(19) United States
(12) Patent Application Publication
(10) Pub. No.: US 2013/0342806 A1
(43) Pub. Date: Dec. 26, 2013

(54) PIEZO BEAM DEVICE

(71) Applicants: Rhishikesh Ashok Sathe, Kirkland, WA (US); Nicholas John Vernon Thompson, Bellevue, WA (US)

(72) Inventors: Rhishikesh Ashok Sathe, Kirkland, WA (US); Nicholas John Vernon Thompson, Bellevue, WA (US)

(21) Appl. No.: 13/734,825

(22) Filed: Jan. 4, 2013

Related U.S. Application Data
(63) Continuation of application No. 13/530,843, filed on Jun. 22, 2012, now abandoned.

(51) Int. Cl. H04R 1/46; G02C 11/00

(52) U.S. Cl. CPC H04R 1/46; G02C 11/00
USPC 351/158; 381/151

(57) ABSTRACT

This document describes techniques and apparatuses for implementing a piezo beam device that is configured to excite vibration in a pinna of an ear of a listener to generate audio for the ear. In some embodiments, the piezo beam device is mounted to one or both temple arms of a pair of eyeglasses to enable the piezo beam device to generate audio for one or both ears of a wearer of the pair of eyeglasses.

### RELATED APPLICATIONS

This application is a continuation of and claims priority under 35U.S.C. §120 to U.S. patent application Ser. No. 13/530,843, filed on Jun. 22, 2012, the disclosure of which is incorporated by reference herein in its entirety.

### BACKGROUND

Typical small-speaker devices are designed to be placed over or plugged into a listener's ears. These devices, such as headphones, earphones, ear buds, and headsets, occlude the listener's ears, which prevents the listener from hearing external or real-world sounds, such as traffic sounds or birds chirping. This causes the listener to be unaware of his or her real-world environment, which can be dangerous, especially when the listener is wearing headphones while jogging or walking on a busy street. Furthermore, by occluding the listener's ears, typical small-speaker devices are not compatible with augmented reality applications that provide audio that augments sounds from the listener's real-world environment.

### SUMMARY

This document describes techniques and apparatuses for implementing a piezo beam device that is configured to excite vibration in a pinna of an ear of a listener to generate audio for the ear. In some embodiments, the piezo beam device is mounted to one or both temple arms of a pair of eyeglasses to enable the piezo beam device to generate audio for one or both ears of a wearer of the pair of eyeglasses.

This summary is provided to introduce simplified concepts in a simplified form that are further described below in the Detailed Description. This summary is not intended to identify essential features of the claimed subject matter, nor is it intended for use in determining the scope of the claimed subject matter.

### BRIEF DESCRIPTION OF THE DRAWINGS

Embodiments of techniques and apparatuses for implementing a piezo beam device are described with reference to the following drawings. The same numbers are used throughout the drawings to reference like features and components:

FIG. 1 illustrates an example environment in which a piezo beam device can be implemented.

FIG. 2 illustrates an example piezo beam device mounted to a pair of eyeglasses.

FIG. 3 illustrates an additional example of a piezo beam device mounted to a pair of eyeglasses.

FIG. 4 illustrates an example method for controlling a piezo beam device.

FIG. 5 illustrates an example device in which techniques for a piezo beam device can be implemented.

### DETAILED DESCRIPTION

Overview

This document describes techniques and apparatuses for implementing a piezo beam device that is configured to excite vibration in a pinna of an ear of a listener to generate audio for the ear. In some embodiments, the piezo beam device is mounted to one or both temple arms of a pair of eyeglasses to enable the piezo beam device to generate audio for one or both ears of a wearer of the pair of eyeglasses.

Example Environment

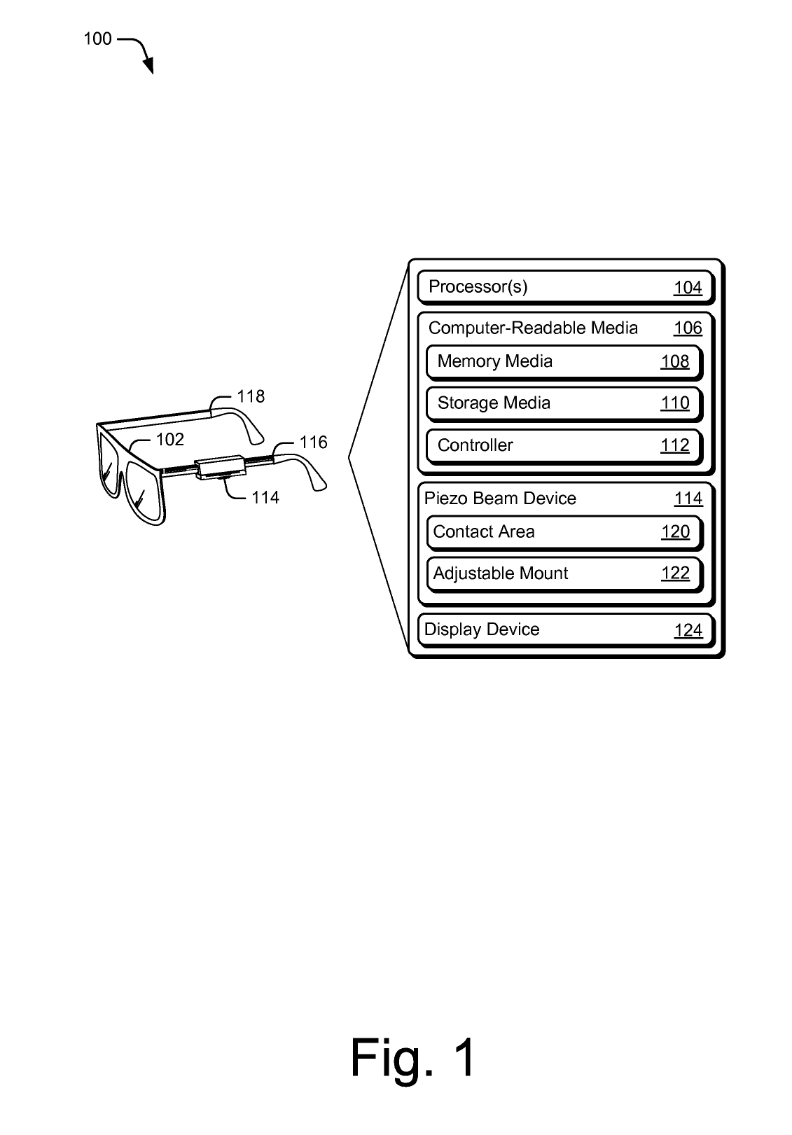

FIG. 1 is an illustration of an example environment 100 in which a piezo beam device can be implemented. Environment 100 can be implemented in a pair of eyeglasses 102, which can include, by way of example and not limitation, sunglasses and any other type of head-mounted device.

Eyeglasses 102 can include processor(s) 104 and computer-readable media 106, which includes memory media 108 and storage media 110. Computer-readable media 106 also includes a controller 112. How controller 112 is implemented and used varies, and is described as part of the method discussed below. In some embodiments, processor 104, computer-readable media 106, storage media 110, and controller 112 can be physically mounted to the frame of eyeglasses 102. In other embodiments, however, one or more of these components may be implemented separate from eyeglasses 102, but communicatively coupled, via a wired or wireless connection, to eyeglasses 102.

Eyeglasses 102 also include a piezo beam device 114 that is mounted to a temple arm 116 of the frame of eyeglasses 102. In some embodiments, piezo beam device 114 is implemented as a piezoelectric transducer. Piezo beam device 114 is configured to be placed in contact with the pinna of a listener's ear, which is the visible part of the ear that resides outside of the listener's head. When an electric signal (Voltage) is applied to the piezo beam device, it is excited and causes mechanical vibrations. Piezo beam device 114, therefore, can be controlled to excite the pinna, which causes the pinna to vibrate and generate audio in a manner similar to a diaphragm in a traditional speaker system. Thus, unlike conventional small-speaker devices, piezo beam device 114 is not configured to be coupled to the eardrum. Instead, the piezo beam device generates audio through the impedance of the pinna. It is to be noted that piezo beam device 114 may also be implemented as a micro-motor or coil-based transducer that is configured to vibrate the pinna of a listener's ear.

In some embodiments, an additional piezo beam device 114 may be mounted to the other temple arm 118 of the frame of eyeglasses 102. Controller 112 controls piezo beam device 114 to generate audio for an ear of a wearer of eyeglasses 102, referred to interchangeably as a “wearer” or a “listener” herein. When an additional piezo beam device 114 is mounted to temple arm 118 of the frame of eyeglasses 102, the piezo beam device can be controlled to generate audio for both ears of the wearer of eyeglasses 102. In some embodiments, controller 112 is configured to control the piezo beam device and the additional piezo beam device to generate the same audio for both ears of the wearer of eyeglasses 102. In other embodiments, controller 112 is configured to control the piezo beam device and the additional piezo beam device to generate stereo audio for both ears of the wearer of eyeglasses 102.

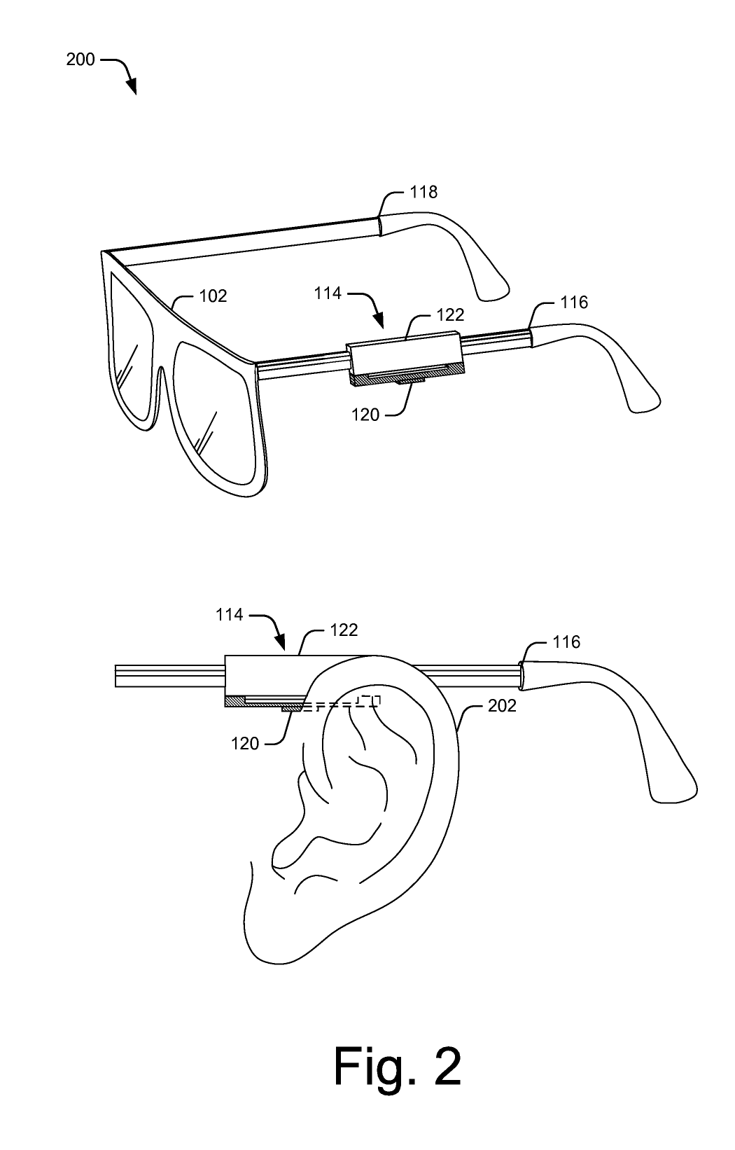

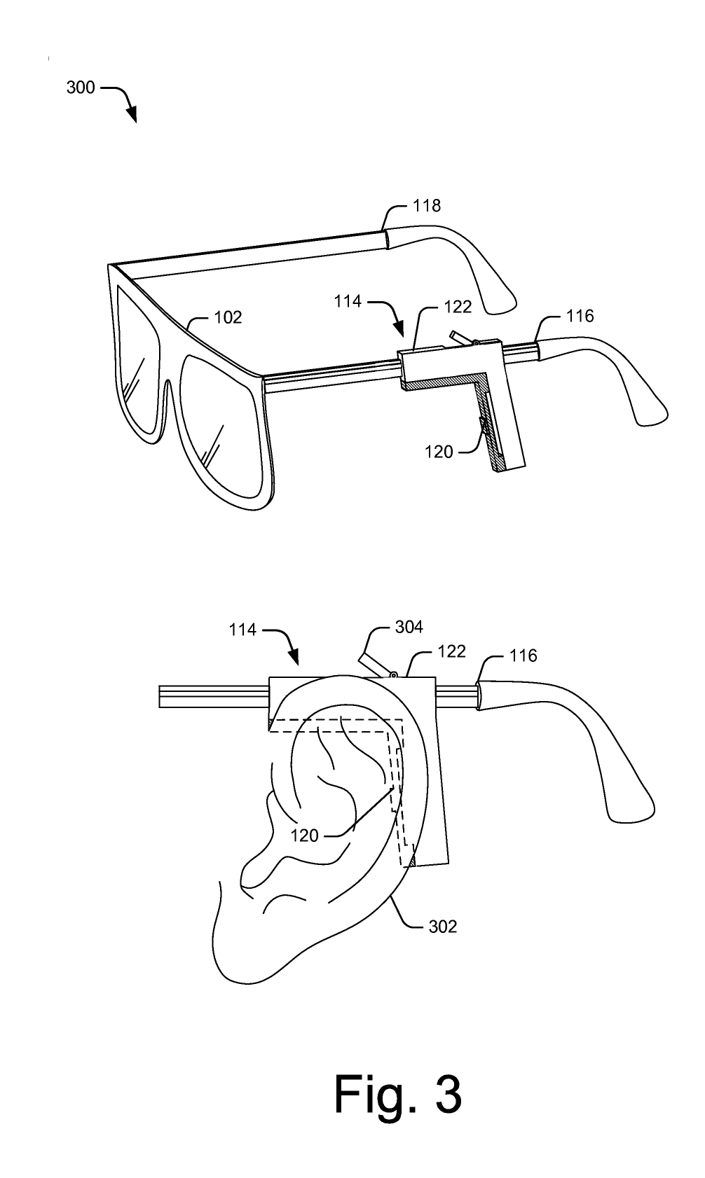

Piezo beam device 114 includes a piezo beam contact area 120 and an adjustable mount 122. As illustrated in more detail in FIGS. 2 and 3 below, piezo beam contact area 120 is the area of piezo beam device 114 that is placed in contact with the listener's pinna to generate audio. To generate the audio, piezo beam device 114 excites vibration in the pinna which creates sound through the cartilage of the pinna into the ear drum and/or through air waves in the environment.

In order to generate audio, the contact area of piezo beam device 114 is placed on the pinna and adjusted so that the piezo beam device applies pressure to the pinna to generate the audio. As described in more detail below, adjustable mount 122 enables piezo beam device 114 to be adjusted by sliding piezo beam device 114 along temple arm 116 to cause contact area 120 to contact the pinna over a wide range of anthropometric positions.

Controller 112 is configured to control piezo beam device 114 to generate audio corresponding an audio signal that is received from an audio source. In some embodiments, the audio source may be implemented as a part of eyeglasses 102. For example, eyeglasses 102 can include receiver circuitry to receive audio signals streamed wirelessly over a network, such as the Internet or a radio network. In another embodiment, eyeglasses 102 can include a storage device that stores audio files that can be controlled by controller 112 for playback by piezo beam device 114. In other embodiments, audio signals can be received from a computing device that is coupled to the controller 112 via a wired or wireless connection. For example, a portable media device (e.g., an mp3 player, laptop, or tablet device) may be coupled to eyeglasses 102 via a wired connection, or via a wireless connection such as a Bluetooth® or a Wi-Fi connection. It is to be appreciated that controller 112 can receive audio signals in a variety of different ways from a variety of different sources, and that the above examples are simply included by way of example and not limitation.

Controller 112 is configured to control piezo beam device 114 to excite vibration in the pinna of the ear of the wearer of eyeglasses 102. The vibration of the pinna generates audio for one or both of the wearer's ears that corresponds to the audio signal. For example, if the audio signal corresponds to a song, then controller 112 controls piezo beam device 114 to excite vibration in the pinna of the ear of the wearer of eyeglasses 102 to generate audio corresponding to the song that can be heard by one or both ears of the wearer.

Piezo beam device 114 excites vibration in the pinna of the listener to generate audio without occluding the ear of the listener. This enables the listener to hear sound from the listener's real-world environment, such as traffic sounds or birds chirping, because the listener's ear is not obstructed or occluded by an over-the-ear speaker or ear bud. This configuration is safer than conventional small-speaker devices as it enables the listener to be more aware of the real-world environment while still being able to listen to audio from piezo beam device 114.

In some embodiments, controller 112 is configured to control piezo beam device 114 to generate audio corresponding to an augmented reality application. Augmented reality is a live, direct or indirect, view of a physical, real-world environment whose elements are augmented by computer-generated sensory input such as audio or video. By not occluding the listener's ears, piezo beam device 114 enables the listener to hear audio corresponding to the real-world environment as well as audio generated by the piezo beam device, which enhances the augmented reality experience. In some embodiments, controller 112 is configured to receive an audio signal that is associated with an augmented reality application, and to control piezo beam device 114 to excite vibration in the pinna of the ear of the listener to generate audio corresponding to the audio signal associated with the augmented reality application. This audio can be mixed with audio from a real-world environment of the listener. In this way, controller 112 creates an optimized augmented reality experience for the listener.

In some embodiments, eyeglasses 102 also includes a display device 124 that is mounted to the frame of eyeglasses 102, and that can be controlled to generate images and/or video for a wearer of the eyeglasses. For example, display device 128 can be a small virtual image projector that is coupled to one or both lenses of eyeglasses 102 and is configured to generate a virtual image of infinitely distant objects directly in front of the eyes of the wearer of the eyeglasses. This virtual image causes a lens of the wearer's eyes to adjust to an infinite or near-infinite focal length to focus on the objects. Display device 124 may be at least partially transparent so that the wearer can see external objects as well as virtual images when looking through the lenses of eyeglasses 102. In addition, it is to be appreciated that display device 124, in some embodiments, may be small enough to fit onto the lenses of eyeglasses 102 without being noticeable to a wearer of the eyeglasses.

In some cases, display device 124 can be implemented as two projectors to generate a virtual image in front of each of the wearer's eyes. When two projectors are used, each projector can project the same virtual image concurrently so that the wearer's right eye and left eye receive the same image at the same time. Alternately, the projectors may project slightly different images concurrently, so that the wearer receives a stereoscopic image (e.g., a three-dimensional image).

Controller 112 can receive a video signal that is associated with the audio signal and control display device 124 to generate a virtual image corresponding to the video signal. Controller 112 can control display device 124 to generate the virtual image concurrently with the audio generated by piezo beam device 114 so that a wearer of eyeglasses 102 can watch video and listen to audio at the same time. For example, a virtual image corresponding to a movie or television show can be generated for the wearer, where the virtual image of the television show is provided by display device 124 and the audio of the television show is provided by piezo beam device 114.

FIG. 2 illustrates a more-detailed example 200 of piezo beam device 114 mounted on eyeglasses 102. In this example, adjustable mount 122 is configured to slide along temple arm 116 of eyeglasses 102 so that contact area 120 of piezo beam device 114 is placed in contact with a pinna 202 of a wearer of eyeglasses 102. In this example, contact area 120 is positioned on a lower face of adjustable mount 122 and is configured to contact a top portion of a rear face of pinna 202.

Adjustable mount 122 may be configured to enable the wearer of eyeglasses 102 to adjust a position of piezo beam device 114 so that the device applies a correct amount of pressure to pinna 202 to generate the audio. In some embodiments, the wearer can manually slide piezo beam device 114 up and down temple arm 116 until piezo beam device is positioned to apply the right amount of pressure to the wearer's pinna. Alternately, in some embodiments adjustable mount 122 can be controlled by controller 112 to automatically position contact area 120 of piezo beam device 114 proximate the top portion of the rear face of pinna 202. Adjustable mount 122 can be locked in place on temple arm 116 once it is positioned correctly so that contact with the top portion of the rear face of pinna 202 is maintained at a constant pressure to ensure adequate audio transmission.

FIG. 3 illustrates another, more-detailed example 300 of piezo beam device 114 mounted on eyeglasses 102. In this example, adjustable mount 122 is again configured to slide along temple arm 116 of eyeglasses 102 so that contact area 120 of piezo beam device 114 is placed in contact with a pinna 302 of a wearer of the eyeglasses 102. Unlike the embodiment illustrated in FIG. 2, however, in this example adjustable mount 122 includes a top section that slides along the temple arm of eyeglasses 102, and a bottom section that is approximately perpendicular or perpendicular to the top section. Contact area 120 is positioned on the lower section of the adjustable mount and is configured to contact a middle portion of a rear face of pinna 302.

Adjustable mount 122 may be configured to enable the wearer of eyeglasses 102 to adjust a position of piezo beam device 114 so that the device applies a correct amount of pressure to pinna 302 to generate the audio. In some embodiments, the wearer can manually slide piezo beam device 114 up and down temple arm 116 until piezo beam device is positioned to apply the right amount of pressure to the wearer's pinna. Alternately, in some embodiments adjustable mount 122 can be controlled by controller 112 to automatically position contact area 120 of piezo beam device 114 proximate the middle portion of the rear face of pinna 302. In this example, adjustable mount 122 can be locked in place on temple arm 116 once it is positioned correctly via a lock 304 so that contact with the middle portion of the rear face of pinna 302 is maintained at a constant pressure to ensure adequate audio transmission.

Example Method

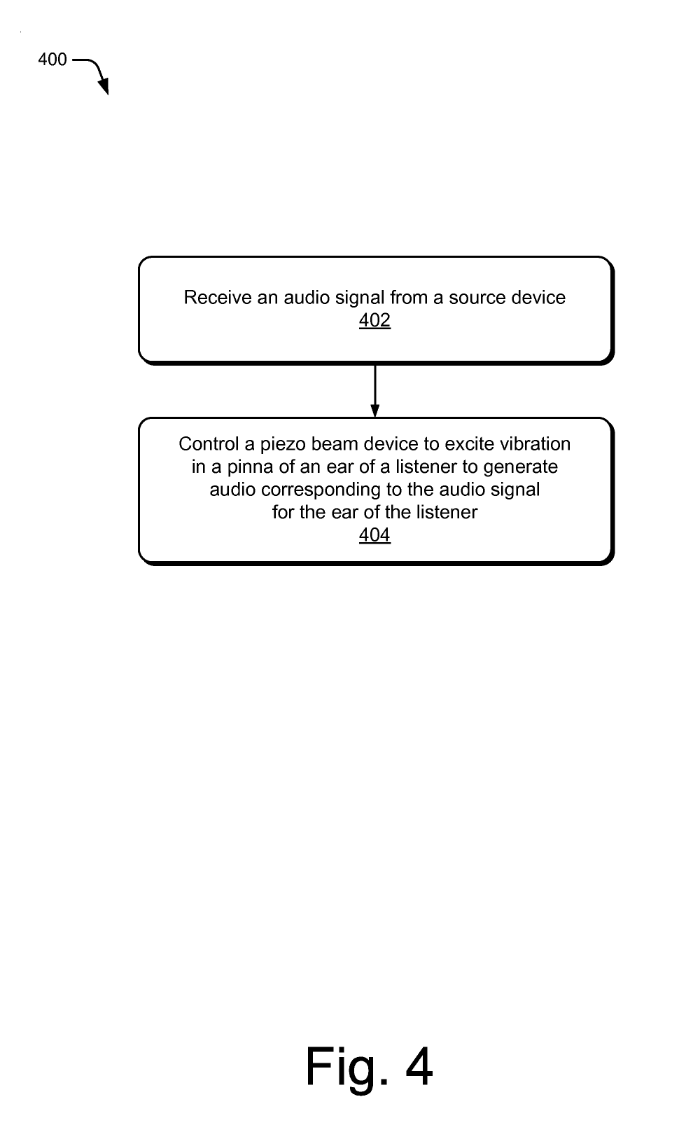

FIG. 4 is flow diagram depicting an example method 400 for controlling a piezo beam device to generate audio. Block 402 receives an audio signal from a source device. For example, controller 112 (FIG. 1) receives an audio signal (e.g., an audio signal corresponding to a song) from a source device mounted on eyeglasses 102, or from a source device that is located remote from eyeglasses 102 and communicatively coupled to eyeglasses 102 via a wired or wireless connection. In some embodiments, the audio signal is associated with an augmented reality application.

Block 404 controls a piezo beam device to excite vibration in a pinna of an ear of a listener to generate audio corresponding to the audio signal for the ear of the listener. For example, controller 112 controls piezo beam device 114, which is mounted on eyeglasses 102, to generate audio corresponding to the audio signal for the ear of a listener that is wearing eyeglasses 102. When the audio signal is associated with an augmented reality application, controller 112 can control piezo beam device 114 to excite vibration in the pinna of the ear of the listener to generate audio corresponding to the audio signal associated with the augmented reality application that is mixed with audio from a real-world environment of the listener to generate an optimized augmented reality experience for the listener.

In some embodiments, controller 112 can also receive a video signal that is associated with the audio signal from the source device (e.g., an audio signal and a video signal corresponding to a movie or a television show). Controller 112 can then control display device 124, mounted to eyeglasses 102, to generate a virtual image corresponding to the video signal for the listener. Controller 112 can generate the audio and the virtual image concurrently so that the listener can watch video and listen to audio at the same time.

Example Device

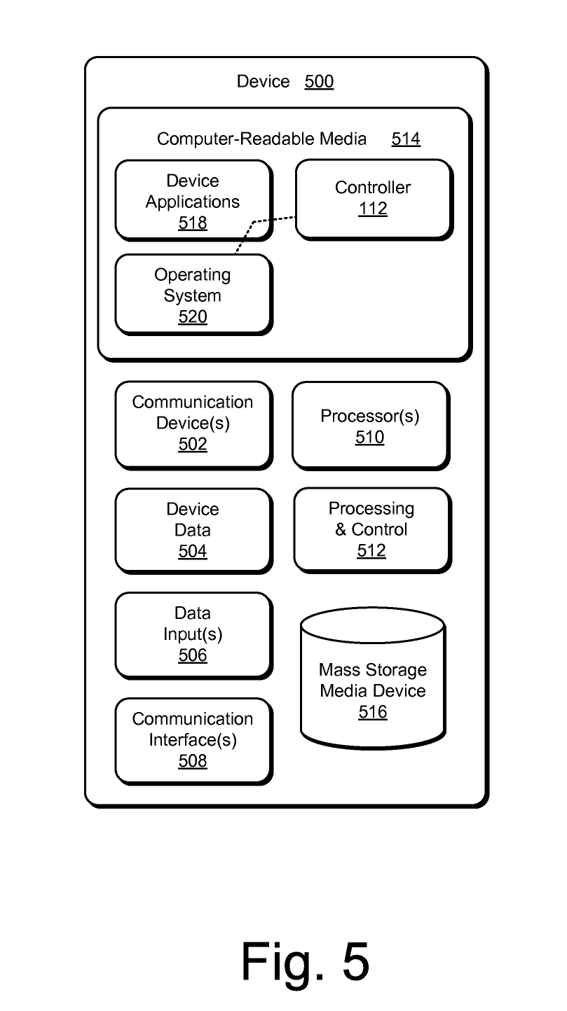

FIG. 5 illustrates various components of example device 500 that can be implemented as any type of head-mounted audio and/or display device, such as eyeglasses 102, as described with reference to the previous FIGS. 1-4 to implement techniques for controlling a piezo beam device. In embodiments, device 500 can be implemented as one or a combination of a wired and/or wireless device, a head-mounted display device (e.g., eyeglasses, sunglasses, etc.), consumer device, computer device, server device, portable computer device, user device, communication device, video processing and/or rendering device, gaming device, electronic device, and/or as another type of device. Device 500 may also be associated with a wearer or a listener (e.g., a person or user) and/or an entity that operates the device such that a device describes logical devices that include users, software, firmware, and/or a combination of devices.

Device 500 includes communication devices 502 that enable wired and/or wireless communication of device data 504 (e.g., received data, data that is being received, data scheduled for broadcast, data packets of the data, etc.). The device data 504 or other device content can include configuration settings of the device, media content stored on the device, and/or information associated with a user of the device. Media content stored on device 500 can include any type of audio, video, and/or image data. Device 500 includes one or more data inputs 506 via which any type of data, media content, and/or inputs can be received, such as user-selectable inputs, messages, music, television media content, recorded video content, and any other type of audio, video, and/or image data received from any content and/or data source.

Device 500 also includes communication interfaces 508, which can be implemented as any one or more of a serial and/or parallel interface, a wireless interface, any type of network interface, a modem, and as any other type of communication interface. The communication interfaces 508 provide a connection and/or communication links between device 500 and a communication network by which other electronic, computing, and communication devices communicate data with device 500.

Device 500 includes one or more processors 510 (e.g., any of microprocessors, controllers, and the like), which process various computer-executable instructions to control the operation of device 500 and to enable techniques for implementing a piezo beam device. Alternatively or in addition, device 500 can be implemented with any one or combination of hardware, firmware, a system-on-chip (SoC), or fixed logic circuitry that is implemented in connection with processing and control circuits which are generally identified at 512. Although not shown, device 500 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 500 also includes computer-readable storage media 514, such as one or more memory devices that enable persistent and/or non-transitory data storage (i.e., in contrast to mere signal transmission), examples of which include random access memory (RAM), non-volatile memory (e.g., any one or more of a read-only memory (ROM), non-volatile RAM (NVRAM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 500 can also include a mass storage media device 516.

Computer-readable storage media 514 provides data storage mechanisms to store the device data 504, as well as various device applications 518 and any other types of information and/or data related to operational aspects of device 500. For example, an operating system 520 can be maintained as a computer application with the computer-readable storage media 514 and executed on processors 510. The device applications 518 may include an augmented reality application, a device manager, such as any form of a control application, software application, signal-processing and control module, code that is native to a particular device, a hardware abstraction layer for a particular device, and so on.

The device applications 518 also include any system components or modules to implement techniques using or enabling a piezo beam device. In this example, the device applications 518 can include controller 112 for controlling a piezo beam device.

### CONCLUSION

This document describes various apparatuses and techniques for implementing a piezo beam device. Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A pair of eyeglasses comprising:
an eyeglass frame comprising a first temple arm and a second temple arm;
a piezo beam device mounted to the first temple arm of the eyeglass frame, the piezo beam device configured to excite vibration in a pinna of an ear of a wearer of the pair of eyeglasses; and
a controller mounted to the eyeglass frame, the controller configured to receive an audio signal and to control the piezo beam device, the control to excite vibration in the pinna of the ear of the wearer to generate audio corresponding to the audio signal.

2. The pair of eyeglasses as described in claim 1, further comprising an additional piezo beam device mounted to the second temple arm of the eyeglass frame, the additional piezo beam device configured to excite vibration in an other pinna of an other ear of the wearer of the pair of eyeglasses.

3. The pair of eyeglasses as described in claim 2, wherein the controller is configured to control the piezo beam device and the additional piezo beam device to generate the same audio for the ear and the other ear of the wearer of the pair of eyeglasses.

4. The pair of eyeglasses as described in claim 2, wherein the controller is configured to control the piezo beam device and the additional piezo beam device to generate stereo audio for the ear and the other ear of the wearer of the pair of eyeglasses.

5. The pair of eyeglasses as described in claim 1, wherein the piezo beam device is configured to be adjusted by sliding the piezo beam device along the first temple arm of the eyeglass frame to cause a contact area of the piezo beam device to contact the pinna of the ear of the wearer.

6. The pair of eyeglasses as described in claim 1, wherein the piezo beam device is configured to be adjusted by sliding the piezo beam device along the first temple arm of the eyeglass frame to cause a contact area of the piezo beam device to contact a top portion of a rear face of the pinna of the ear of the wearer.

7. The pair of eyeglasses as described in claim 1, wherein the piezo beam device is configured to be adjusted by sliding the piezo beam device along the first temple arm of the eyeglass frame to cause a contact area of the piezo beam device to contact a middle portion of a rear face of the pinna of the ear of the wearer.

8. The pair of eyeglasses as described in claim 1, wherein the piezo beam device is configured to excite vibration in the pinna of the ear of the wearer to generate the audio without occluding the ear of the wearer.

9. The pair of eyeglasses as described in claim 1, wherein the audio signal is associated with an augmented reality application, and wherein the controller is configured to control the piezo beam device to excite vibration in the pinna of the ear of the wearer to generate the audio corresponding to the audio signal that is mixed with additional audio from a real-world environment of the wearer.

10. The pair of eyeglasses as described in claim 1, further comprising a display device mounted to the eyeglass frame, wherein the controller is further configured to receive a video signal that is associated with the audio signal, and to control the display device to generate a virtual image corresponding to the video signal.

11. A method comprising:
receiving an audio signal from a source device; and
controlling a piezo beam device to excite vibration in a pinna of an ear of a listener to generate audio corresponding to the audio signal for the ear of the listener.

12. The method as described in claim 11, wherein the piezo beam device and the source device are mounted to a pair of eyeglasses.

13. The method as described in claim 11, wherein the piezo beam device is mounted to a pair of eyeglasses, and wherein the source device is located remote from the pair of eyeglasses and communicatively coupled to the piezo beam device via a wired or wireless connection.

14. The method as described in claim 11, further comprising controlling an additional piezo beam device to excite vibration in an other pinna of an other ear of the listener to generate audio corresponding to the audio signal for the other ear of the listener.

15. The method as described in claim 11, wherein the audio signal is associated with an augmented reality application.

16. The method as described in claim 15, wherein the controlling further comprises controlling the piezo beam device to excite vibration in the pinna of the ear of the listener to generate audio corresponding to the audio signal associated with the augmented reality application, the audio mixed with audio from a real-world environment of the listener.

17. The method as described in claim 11, wherein the piezo beam device is mounted to a pair of eyeglasses having a display device, and further comprising:
receiving a video signal that is associated with the audio signal from the source device; and
controlling the display device to generate a virtual image corresponding to the video signal for the listener.

18. A piezo beam device comprising:
an adjustable mount configured to mount the piezo beam device to a temple arm of a pair of eyeglasses and to enable the piezo beam device to be adjusted by sliding the piezo beam device along the temple arm of the pair of eyeglasses to place a contact area of the piezo beam device in contact with a pinna of an ear of a wearer of the pair of eyeglasses; and
a controller configured to control the piezo beam device to excite vibration in the pinna of the wearer of the pair of eyeglasses, the vibration causing the audio to be generated for the wearer when the contact area of the piezo beam device is placed in contact with the pinna of the ear of the wearer.

19. The piezo beam device as recited in claim 18, wherein the contact area is positioned on a lower face of the adjustable mount and is configured to contact a top portion of a rear face of the pinna of the wearer.

20. The piezo beam device as recited in claim 18, wherein the adjustable mount includes a top section and a bottom section that is perpendicular to the top section, wherein the top section of the adjustable mount is configured to slide along the temple arm of the pair of eyeglasses, and wherein the contact area is positioned on the bottom section of the adjustable mount and is configured to contact a middle portion of a rear face of the pinna of the ear of the wearer.
